(19) United States
(12) Patent Application Publication
(10) Pub. No.: US 2015/0221431 A1
(43) Pub. Date: Aug. 6, 2015

(54) Modularized planar coil layer and planar transformer using the same

(71) Applicant: Wen-Hsiang WU LI, New Taipei (TW)

(72) Inventor: Wen-Hsiang WU LI, New Taipei (TW)

(21) Appl. No.: 14/173,214

(22) Filed: Feb. 5, 2014

(51) Int. Cl. H01F 27/29

(52) U.S. Cl. CPC H01F 27/292

(57) ABSTRACT

Disclosed is a modularized planar coil in the form of a planar coil layer and comprising a coil main body and two pads extended from both ends of the coil main body. The pads respectively locate at a first position at periphery of an imaginary geometric shape that encloses the coil main body and a second position apart from the first position at peripheral of the geometric shape. Winding assemblies of a plurality of the invented planar coil layers and transformers including the invented coil layers are also disclosed. The invention provides a planar transformer that is easy to prepare and useful in the SMT technology.

### FIELD OF THE INVENTION

The present invention relates to a modularized planar coil, especially to a planar coil layer for use in planar transformers. This invention provides modularized planar coils that may be easily connected in series to form a multilayered planar coil module. The present invention also provides a planar transformer including the invented planar coil.

### BACKGROUNDS OF THE INVENTION

The transformer is an important component for all kinds of electronic products. The traditional transformer is bulky and heavy, therefore not useful in most nowadays electronic components. The planar transformer was then invented to provide the possibility of down-sizing and surface-mounting the transformer. A planar transformer includes plural layers of printed circuit boards provided with winding coils of conductive sheets, such as copper sheets, which reduce the thickness of the coils. The planar transformer is widely used in components in the fields of communications, computer, industrial control, aerospace engineering, medication etc. However, because printed circuit boards are used as substrate of the coils, the conventional planar transformer is thick and inefficient and generates high resistance and noises. Therefore, it is necessary for the industry to provide a thin and efficient planar transformer.

Taiwan patent No. TW I 387981 discloses a planar transformer, comprising a single, multilayered printed circuit board (PCB). The PCB includes a plurality of primary winding, a plurality of secondary winding and a through hole for a core to be arranged therein. This patent provides the possibility of laminating a plurality of winding layers in one PCB, whereby the thickness of the transformer is dramatically reduced. The structure disclosed in this patent is substantially identical to the traditional planar transformer, except that the PCB in the traditional planar transformer is replaced by a thin circuit layer.

Taiwan patent No. TW I 357086 provides a transformer arranged in a PCB. The transformer includes a first planar coil and a second planar coil, wherein the first coil includes a plurality of first loop and the second coil includes a plurality of second loop. At least two neighboring first loops form a first bundle of coils and at least two neighboring second loops form a second bundle of coils. The loops of the first bundle partially interpose that of the second.

Chinese patent No. CN 103081044A also discloses a planar transformer. The transformer comprises a plurality of single-layered, single-looped coils. Primary winding and secondary windings are formed by the single layered coils.

European patent EP 2 602 801A1 discloses a planar transformer comprising a secondary winding that includes a plurality of single-layered, single-looped coil layers. The primary winding is formed by a wire wound in a spiral along the secondary winding.

German patent application No. DE 10 2012 003 365A1 discloses a planar transformer that includes windings in the form of a single-layered and multiple-looped, planar structure. The terminal of the inner loop bends to pass a through hole provided at center of substrate on which the planar structure is arranged, to the opposite side of the substrate.

European patent No. EP 2 637 183A2 discloses a planar transformer that includes single-layered, single-looped coil layers as its windings. The coil layers extend to provide pads, to serve as connecting pins with another layer or electrodes.

US patent publication No. US 2013/278371A1 discloses a planar transformer comprising a plurality of single-layered planar coils. A plurality of coils is connected and positioned by terminal pins vertically, to form coils of multiple loops.

WO 0070926A1 discloses a planar transformer including windings made by a single element. A sheet of conductive material is so designed, that when it is bent a multiple-layered, single-looped coil assembly is formed. The layers are connected by tabs in the form of a pad.

From the disclosure of these and other patents and non-patent documents, it is understood that the industry have spent substantial efforts in the development of planar transformer, in order to reduce its thickness and to enhance its performance. However, the structure of the planar transformer so developed remains the same of the PCB-style. Most solutions are the assembly of single-layered coils or coil layers as their units. The connections between two coils or layers are specifically designed, so that they suited only for particular coil structures, i.e., coil assemblies of particular number of layers and loops. None of them has provided modularized designs for the coils, so that coils modules having standard interfaces may be selectively assembled, to form coil assemblies that satisfy the diversified needs in the industry.

### OBJECTIVES OF THE INVENTION

An objective of this invention is to provide a modularized planar coil and a planar coil module including a plurality of the planar coil connected in series.

Another objective of this invention is to provide a planar coil that may be assembled to form planar coil assemblies with selected numbers of coils.

Another objective of this invention is to provide modularized planar coils with substantially identical main body and selectable pad positions.

Another objective of this invention is to provide a planar transformer that includes a modularized planar coil or an assembly of modularized planar coils.

Another objective of this invention is to provide a planar coil that is usable in surface mounting, and a planar transformer using the same.

### SUMMARY OF THE INVENTION

According to this invention, a modularized planar coil layer is provided and comprises a coil main body and two pads extended from both ends of the coil main body. The pads respectively locate at a first position at periphery of an imaginary geometric shape that encloses the coil main body and a second position apart from the first position at peripheral of the geometric shape.

In the preferred embodiments of this invention, the geometric shape is a rectangle enclosing the coil main body, while in other embodiments the geometric shape is a polygon or a circle enclosing the coil main body.

In some preferred embodiments, the modularized planar coil layer further includes an insulation sheet. In such embodiments, the main body is provided on the insulation sheet and the pads extend to external of the insulation sheet.

In some embodiments the main body forms substantially a donut shape, while in other embodiments, the main body forms substantially a polygon frame.

According to another aspect of this invention, a planar coil assembly is provided and comprises at least one first planar coil layer and a second planar coil layer. In the assembly, the first and second planar coil layers respectively comprise a coil main body and two pads extended from both ends of the coil main body. The two coil main bodies have substantially identical shape, are stacked and are separated by a first predetermined distance. Pads of the first planar coil layer respectively locate at a first position at periphery of an imaginary geometric shape that encloses the coil main bodies and a second position apart from the first position at periphery of the geometric shape. Pads of the second planar coil layer respectively locate at a second position at periphery of the imaginary geometric shape and a third position apart from the first and second positions at peripheral of the geometric shape. The first and second planar coil layers are connected in series at the second position. In the preferred embodiments, pads at the first and third positions respectively form a bonding pad at the same plane.

In some preferred embodiments, the planar coil assembly further includes an insulation sheet, provided between the first and second planar coil layers. In such embodiments, the pads extend to external of the insulation sheet.

The planar coil assembly may further include a third planar coil layer. The third planar coil layer comprises a coil main body and two pads extended from both ends of the coil main body. The coil main body has a shape substantially identical to that of the first and second planar coil layers, is stacked to the first and second planar coil layers and separated from its neighboring planar coil layer at a second predetermined distance. Pads of the third planar coil layer respectively locate at the third position at periphery of the imaginary geometric shape and a fourth position apart from the first to third positions at peripheral of the geometric shape. The third and second planar coil layers are connected in series at the third position.

In some preferred embodiments, the planar coil assembly further includes an insulation sheet, provided between the third and second planar coil layers. The first and second predetermined distances may be identical or different.

The planar coil assembly may further include a fourth planar coil layer. The fourth planar coil layer comprises a coil main body and two pads extended from both ends of the coil main body. The coil main body has a shape substantially identical to that of the first to third planar coil layers, is stacked to the first to third planar coil layers and separated from its neighboring planar coil layer at a third predetermined distance. Pads of the fourth planar coil layer respectively locate at the fourth position at periphery of the imaginary geometric shape and a fifth position apart from the first to fourth positions at peripheral of the geometric shape. The fourth and third planar coil layers are connected in series at the fourth position.

The planar coil assembly further includes an insulation sheet, provided between the fourth and third planar coil layers. The third predetermined distance may be identical to one of the first and second predetermined distances. In the preferred embodiments, pads at the first and fifth positions respectively form a bonding pad at the same plane. In some other embodiments, pads at the first, third and fifth positions respectively form a bonding pad at the same plane.

A planar transformer using the modularized planar coil layers of this invention may comprise a planar coil layer or an assembly of planar coil layers, a planar coil module stacked to the planar coil layer or assembly, and a core. The core extends orthogonally to the plane of the planar coil layer/assembly and the planar coil modules and passes through their central portions. The planar transformer may further include a casing that encloses the core and the coil portions of the planar coil layer/assembly and planar coil modules.

These and other objectives and advantages of this invention will be clearly understood from the detailed description by referring to the following drawings.

### BRIEF DESCRIPTION OF THE DRAWINGS

FIG. 1 shows the structure of a planar transformer including modularized planar coil layers of this invention.

FIG. 2 is the perspective view of the first embodiment of the modularized planar coil layer of this invention.

FIG. 3 is the perspective view of the second embodiment of the modularized planar coil layer of this invention.

FIG. 4 is the perspective view of the third embodiment of the modularized planar coil layer of this invention.

FIG. 5 is the perspective view of the fourth embodiment of the modularized planar coil layer of this invention.

FIG. 6 shows one example of the connection of four modularized planar coil layers of this invention.

### DETAILED DESCRIPTION OF THE INVENTION

Detailed description to several preferred embodiments of this invention will be given below. It is however appreciated that the detailed description serves only for illustration of certain aspects of this invention, without limitation to the scope of protection.

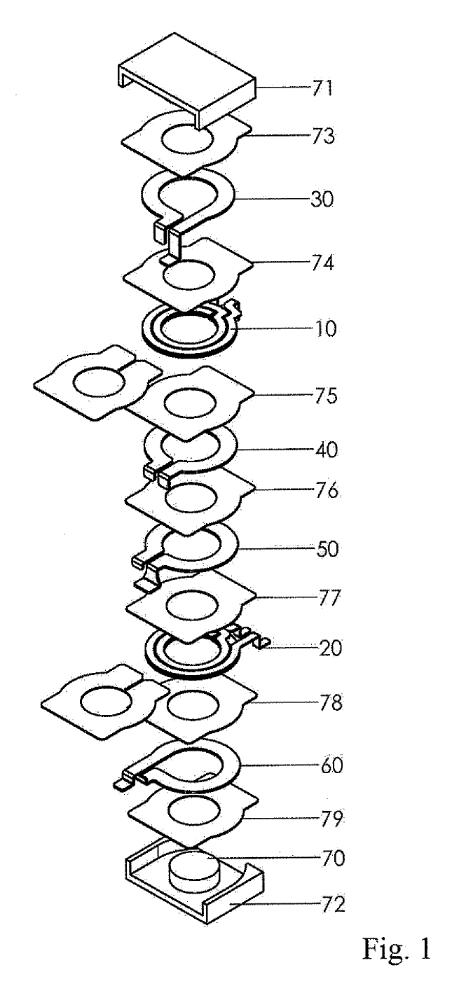

FIG. 1 shows the structure of a planar transformer that includes four modularized planar coil layers of this invention. As shown in this figure, the planar transformer 1 includes from top to bottom the following elements: Upper casing 71, insulation sheet 73, first coil layer 30, insulation sheet 74, first planar coil module 10, insulation sheet 75, second coil layer 40, insulation sheet 76, third coil layer 50, insulation sheet 77, second planar coil module 20, insulation sheet 78, fourth coil layer 60, insulation sheet 79, lower casing 72, and a core passing through the central portions of the coil layers, the coil modules and the insulation sheets. In the structure shown in FIG. 1, the first coil layer 30, the second coil layer 40, the third coil layer 50 and the fourth coil layer 60 are connected in series, to function as secondary winding of the transformer 1. The first planar coil module 10 and the second planar coil module 20 are connected in series and function as primary winding of the transformer 1. Of course, in this structure, the first and second windings are interchangeable.

For purpose of description, in the following the term “primary winding” will denote to the first planar coil module 10 and/or the second planar coil module 20 and the term “secondary winding” will denote to all or a part of the first coil layer 30, the second coil layer 40, the third coil layer 50 and the fourth coil layer 60. Therefore, in the following description, “primary winding” and “secondary winding” are interchangeable and represent the relative elements of the transformer.

Also as shown in this figure, the primary winding includes two double-layered, double-looped planar coil modules 10 and 20. On the other hand, the secondary winding includes four single-layered, single-looped planar coil layers. As may be appreciated by those having ordinary skills in the art, the first winding may include any number of planar coil layers, alone or in combination with one or more than one planar coil module, such as planar coil module 10, 20. Numbers of the primary and secondary windings are not limited by these embodiments. The planar coil modules 10, 20 shown in FIG. 1 have been discussed in Taiwan patent application filing No. 102143037. Its disclosures are included for reference in this invention. As also shown in this figure, planar coil modules 10, 20 connect in series, to form the primary winding.

The structure, respective number and arrangements of the primary winding coils and the secondary winding coils as shown in this figure are exemplary. Those having ordinary skills in the art will appreciate that a variety of combinations and arrangements of the coils may be used in a planar transformer. For example, both the primary winding and the secondary winding may consist of only the single-layered single-looped planar coil layers of this invention. Number of the coil layers is not limited. General speaking, the total number of loops in the primary winding shall differ from that of the secondary winding. However, in some applications, identical number of loops is used in the primary winding and the secondary winding. Preferably, the coils of the primary winding and the secondary winding interleave, so to enhance the performance of the transformer. Insulation sheets may be provided between each two coil layers. Of course, it is possible to provide insulation in other forms, such as insulation materials provided on the surface of the coils. Materials for the insulation sheets or surface insulation are not limited. Commercially available materials may be used, as long as they are easily processed and provide required insulation effects. If insulation sheets are used, thickness of the sheets should be so determined that the insulation sheets are not so thick as to impact the induction of the coils and not so thin as to damage the insulation effects.

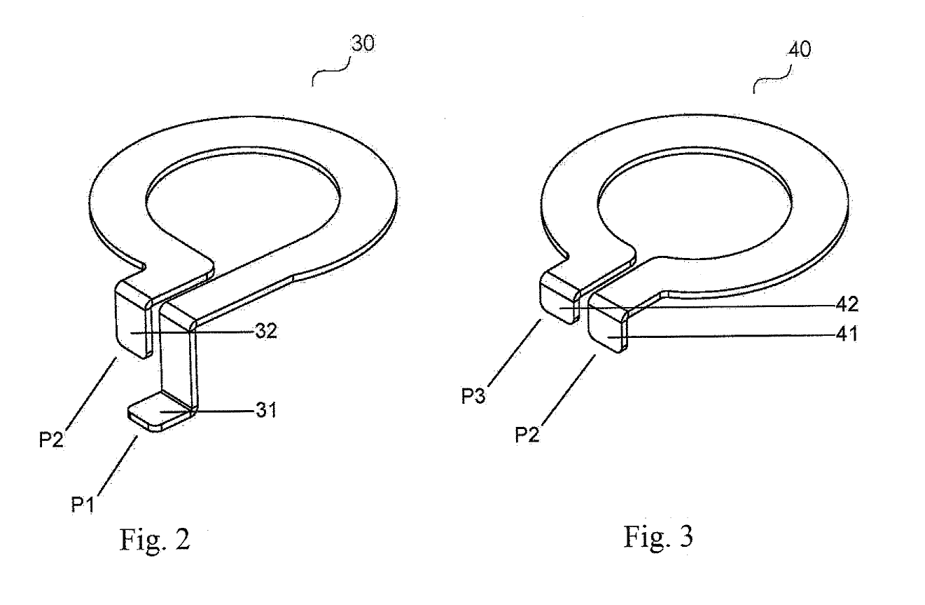

In the structure shown above, coils 30, 40, 50, 60 of the secondary winding are examples of the modularized planar coil layer of this invention. As shown in the figure, the planar coil modules 10, 20 respectively have two pads extended from the modules. In addition, as also shown in FIGS. 2-5, the planar layers 30, 40, 50, 60 respectively have two pads extended from the coils, at a side opposite to the side where the pads of planar coil modules 10, 20 extend. Of course, the present invention is not limited to such arrangements. It is possible to arrange all or a part of the pads of the primary winding at the side where all or a part of the pads of the secondary winding is arranged.

These elements are assembled to form a planar transformer 1. In the transformer 1, upper casing 71 and lower casing 72 enclose the core 70 and the coil portions of the planar coil modules 10, 20 and the coil layers 30, 40, 50, 60. The casings 71, 72 do not only protect the transformer 1 but also provide EMR shielding functions. Three pads of the planar coil modules 10, 20 and three pads 31, 42, 62 of the coil layers 30, 40, 50, 60 bend to form soldering pads, at the same plane or height so that the planar transformer 1 may be mounted on a circuit board using the surface mounting (SMT) technology. Length of the pads is determined according to the distance between their respective coil main bodies and the plane where the soldering pads locate.

In the embodiments of this invention, the planar coil modules 10, 20 are made by materials with high conductivity. Suited materials include all kinds of metal or alloys, such as copper, silver, brass etc. On the other hand, the core 70 may be any type of commercially available cores. The material, shape and size of the core 70 may be determined by those having ordinary skills in the art in accordance with related requirements and conditions in particular applications. In addition, casing for the transformer is not limited to any form. A casing made from one-piece blank or by the assembly of more than two elements may also be used in this invention. If necessary, one of the upper casing and the lower casing may be omitted. It is also possible to use more than one or one layer of upper casing and/or lower casing. These are, of course, not any technical limitation.

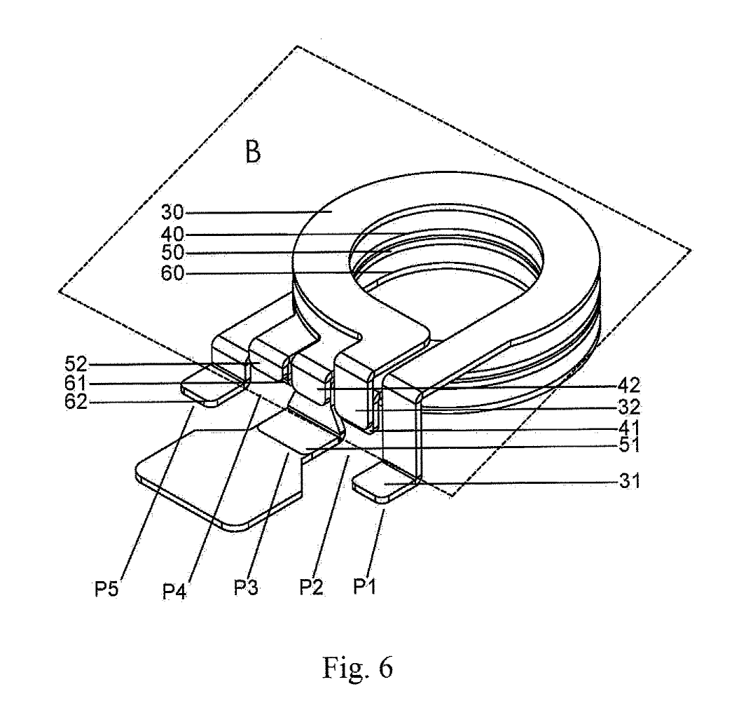

FIG. 2 shows the perspective view of one embodiment of the modularized planar coil layer of this invention. The planar coil layer shown in FIG. 2 corresponds to first planar coil layer 30 of FIG. 1. The first planar coil layer 30 includes a coil main body and two pads 31, 32 extended from both ends of the coil main body. According to this invention, the pads 31, 32 respectively extend at a first position P1 at periphery of an imaginary geometric shape that encloses the coil main body and a second position P2 apart from the first position P1 at periphery of the imaginary geometric shape. To be more specific, the “imaginary geometric shape” may be a rectangle that encloses the region occupied by the coil main body. For example, the imaginary geometric shape may be the rectangle projected by the upper casing 71 and the lower casing 72 on a plane where the main body locates, such as block B of dotted line in FIG. 6. In such a case, the pads 31 and 32 respectively extend at a first position P1 and a second position P2, at one side or two sides of the rectangle B of FIG. 6. When used in the SMT technology, first position P1 and second position P2 are respectively arranged at bonding pad positions of the planar transformer. In other embodiments, the imaginary geometric shape may be a circle or a polygon that encloses the regions occupied by the coil main body, as the imaginary geometric shape may be any shape that supports the applications of the planar transformer. The pads 31, 32 may be bent to form bonding pads for use in the SMT process. In addition, one or more pads 31, 32 may further extend transversely to form bonding pads of large size, to provide securing and/or heat-dissipation functions, see FIG. 6.

In the embodiment of FIG. 6, pad 31 is arranged at one of the positions where bonding pads of the standard surface mounting device (SMD) locate. Since first planar coil layer 30 is at a relatively high level, pad 31 extends relatively long in the height direction. As pad 32 serves only to contact a pad of the second planar coil layer 40, it extends a length sufficient to contact the second planar coil layer 40. Of course, if only one planar coil layer is used as the secondary winding, no such length arrangements are necessary.

In the preferred embodiments, the modularized planar coil layer may further include an insulation sheet 74. In such embodiments, the insulation sheet 74 in addition serves to secure the planar coil layer 30 and pads 31, 32 extend to external of the insulation sheet 74. The first coil layer 30, the insulation sheet 74 and the first planar coil module 10 generally form a planar transformer.

In the embodiment of FIG. 2, the coil main body 30 forms substantially a donut shape, while in other embodiments, the coil main body 30 forms substantially a loop in the form of a rectangular frame or other polygonal frames. The width, thickness and even shape of the coil layer 30 may be determined according to conditions in particular applications. Generally speaking, the coil main body is preferably formed in a planar loop, so to save material and to simplify process of the windings. Material for the coil layer 30 may be any conductive material. Suited materials include all kinds of metal or alloys, such as copper, silver, brass etc. If material costs, manufacture costs, conductivity and ease of assembly are considered, copper foil would be a preferred material. This, however, is not any technical limitation.

FIG. 3 shows the perspective view of another embodiment of the modularized planar coil layer of this invention. As shown in this figure, the planar coil layer of this embodiment corresponds to second planar coil layer 40 in FIG. 1. The structure of the second planar coil layer 40 is substantially identical to that of the first planar coil layer 30, as it also includes a coil main body and two pads 41, 42 extended from the coil main body. In this example, pads 41, 42 respectively extend at the second position P2 at periphery of the imaginary geometric shape B and a third position P3 apart from the first position P1 and the second position P2 at periphery of the imaginary geometric shape, as is also shown in FIG. 6. In this example, pads 41, 42 are not bent to form bonding pads but simply serve to connect the first planar coil layer 20 and the third coil layer 50. Corresponding to the relative levels of planes where the second planar coil layer 40, the first planar coil layer 30 and the third planar coil layer 50 locate in the planar transformer 1, pads 41, 42 provide relatively short lengths. Of course, if the secondary winding includes only two planar coil layers 30, 40, pad 42 of the second planar coil layer 40 would extend to the height of pad 31 of the first planar coil layer 30 and bend to form a bonding pad.

In the example of FIG. 3 an insulation sheet 74 may be provided between the first planar coil layer 30 and the second planar coil layer 40. However, since in the example of FIG. 1 the first planar coil module 10 is arranged between the first planar coil layer 20 and the second planar coil layer 40, two insulation sheets 74, 75 are provided between the first planar coil layer 30 and the first planar coil module 10 and between the second planar coil layer 40 and the first planar coil module 10, respectively. The first coil layer 30, the first planar coil module 10 and the second planar coil layer 40 generally form a planar transformer. In this embodiment, the first planar coil module 10 may be arranged between the first planar coil layer 30 and the second planar coil layer 40 or stacked on or below the first planar coil layer 30 and the second planar coil layer 40.

Also in the example of FIG. 3 the coil main body 40 forms substantially a donut shape. Other shape may be used in the coil main body 40, as long as it forms substantially a loop. Material, width, thickness and shape for the second planar coil layer 40 is not limited but are preferably identical to that of the first planar coil layer 30, to simplify process of the planar transformer 1.

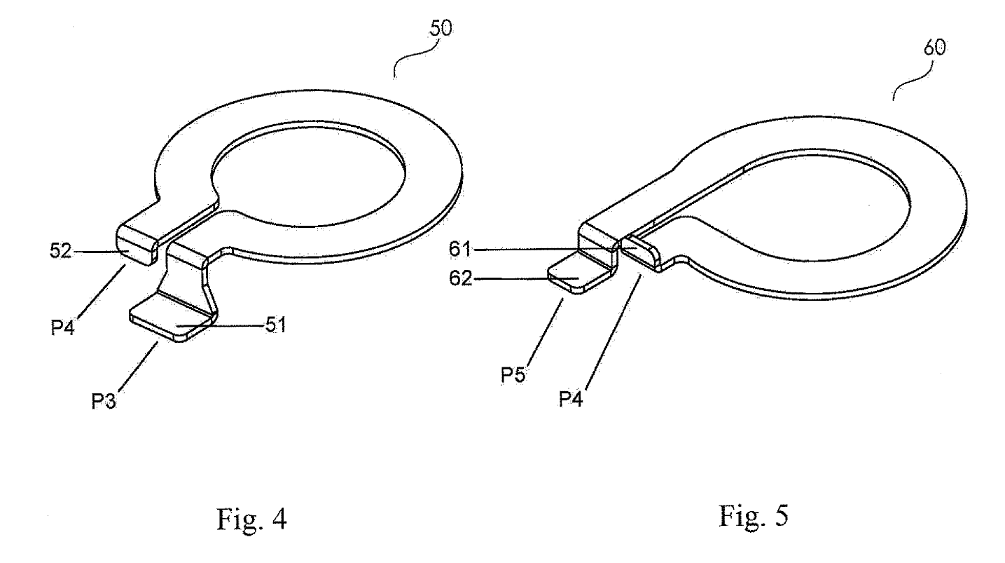

FIG. 4 shows the perspective view of the third embodiment of the modularized planar coil layer of this invention. As shown in this figure, the planar coil layer of this embodiment corresponds to third planar coil layer 50 in FIG. 1. The structure of the third planar coil layer 50 is substantially identical to that of the first and second planar coil layers 30, 40, as it also includes a coil main body and two pads 51, 52 extended from the coil main body. In this example, pads 51, 52 respectively extend at the third position P3 at periphery of the imaginary geometric shape B and a fourth position P4 apart from the first to third positions P1, P2 and P3, at periphery of the imaginary geometric shape, as is also shown in FIG. 6. In this example, pad 51 of the third planar coil layer 50 bends to form a bonding pad and serves to connect the second planar coil layer 40 at the same time. On the other hand, pad 52 does not bend to form a bonding pad but simply serves to connect the fourth planar coil layer 60. Corresponding to the relative levels of planes where the third planar coil layer 50, the second planar coil layer 40 and the fourth planar coil layer 60 locate in the planar transformer 1, pad 51 provides a medium length and pad 52 provides a relatively short length. Of course, if the secondary winding includes only the first planar coil layer 30, the second planar coil layer 40 and the third planar coil layer 50, pad 52 of the third planar coil layer 50 would extend to the height of pad 31 of the first planar coil layer 30 and bend to form a bonding pad. In such a case, pad 51 provides a relatively short length, as long as is sufficient to connect pad 42 of the second planar coil layer 40 in series.

In the example of FIG. 1 an insulation sheet 76 is provided between the second planar coil layer 40 and the third planar coil layer 50. Basically the first planar coil layer 30, the first planar coil module 10, the second planar coil layer 40 and the third planar coil layer 50 form a planar transformer, wherein the first planar coil module 10 may be provided between the first planar coil layer 30 and the second planar coil layer 40 or between the second planar coil layer 40 and the third planar coil layer 50, or stacked on or below the first planar coil layer 30, the second planar coil layer 40 and the third planar coil layer 50. In addition, the first planar coil module 10, the second planar coil layer 40 and the third planar coil layer 50 may also form a planar transformer.

Also in the example of FIG. 4 the coil main body 50 forms substantially a donut shape. Other shape may be used in the coil main body 50, as long as it forms substantially a loop. Material, width, thickness and shape for the second planar coil layer 50 is not limited but are preferably identical to that of the first planar coil layer 30 and the second planar coil layer 40, to simplify process of the planar transformer 1.

FIG. 5 shows the perspective view of the fourth embodiment of the modularized planar coil layer of this invention. As shown in this figure, the planar coil layer of this embodiment corresponds to fourth planar coil layer 60 in FIG. 1. The structure of the fourth planar coil layer 60 is substantially identical to that of the first to third planar coil layers 30, 40, 50, as it also includes a coil main body and two pads 61, 62 extended from the coil main body. In this example, pads 61, 62 respectively extend at the fourth position P4 at periphery of the imaginary geometric shape B and a fifth position P5 apart from the first to fourth positions P1, P2, P3 and P4, at periphery of the imaginary geometric shape, as is also shown in FIG. 6. In this example, pad 62 of the fourth planar coil layer 60 provides a relative short length and bends to form a bonding pad, while pad 61 does not bend to form a bonding pad but simply serves to connect the third planar coil layer 50. Corresponding to the relative levels of planes where the fourth planar coil layer 60 and the series connected third planar coil layer 50 locate in the planar transformer 1, pad 61 extends upwards in the figure and provides a relatively short length. Of course, if the secondary winding includes only the second planar coil layer 40, the third planar coil layer 50 and the fourth planar coil layer 60, or only the third planar coil layer 50 and the fourth planar coil layer 60, pads 61, 62 of the fourth planar coil layer 60 would extend to proper heights, in order to provide bonding pads at the same plane. Of course, whether or not all the bonding pads locate in the same plane, may be determined by designers according to needs in particular applications.

In the example of FIG. 1 the second planar coil module 20 is provided between the third planar coil layer 50 and the fourth planar coil layer 60. Insulation sheets 77, 78 are respectively provided between the first planar coil module 10 and the third and fourth planar coil layers 50, 60. Similarly, insulation sheets may be provided on and below the fourth planar coil layer 60, respectively, is necessary. The relative positions of the first planar coil module 10, the third planar coil layer 50 and the fourth planar coil layer 60 are not limited to what is shown in the figures.

Basically the first planar coil layer 30, the first planar coil module 10, the second planar coil layer 40, the third planar coil layer 50, the second planar coil module 20 and the fourth planar coil layer 60 form a planar transformer. Similarly, a planar transformer may be constituted by any combination of these planar coil modules and planar coil layers.

The coil main body 60 shown in FIG. 5 forms substantially a donut shape. Other shape may be used in the coil main body 60, as long as it forms substantially a loop. Material, width, thickness and shape for the second planar coil layer 60 is not limited but are preferably identical to that of the first to third planar coil layers 30, 40 and 50, to simplify process of the planar transformer 1.

FIG. 6 shows one example of the connection of the planar coil layers of this invention. In his embodiment, the first planar coil layer 30, the second planar coil layer 40, the third planar coil layer 50 and the fourth planar coil layer 60 are stacked in sequence and connected in series, to form a winding assembly. Note that the assembly shown in FIG. 6 differs from the assembly shown in FIG. 1, although corresponding components are labeled with identical reference numbers. The assembly in FIG. 6 is simply a stack of planar coil layers of this invention, to form the secondary winding, without any coil of the primary winding arranged between the planar coil layers. However, in the application of the invented planar coil layers, distance between planar coil layers may vary in accordance with their relative levels (heights) in the planar transformer and type and number of planar coil layer or planar coil modules of the primary winding positioned between the planar coil layers. That is, lengths of the pad extension may be easily determined in accordance with arrangements of the planar coil layers and the planar coil modules accommodated in the planar transformer.

In the particular example shown in FIG. 6, order of the series connection of the planar coil layers is: From pad 31 of the first planar coil layer 30 at position P1 to coil main body 30 then to pad 32 at position P2. Pad 32 does not extend to form a bonding pad but connects with pad 41 of the second planar coil layer 40 at position P2. From here, connection continues to coil main body 40 and to pad 42 at position P3, where pad 42 connects pad 51 of the third planar coil layer 50 at position P3. Pad 51 forms a bonding pad and at the same time expands vertically to form a heat dissipation pad. From pad 51, connection continues to coil main body 50, then to pad 52 at position P4. Pad 52 does not extend to form a bonding pad but simply connects pad 61 of the fourth planar coil layer 60 at position P4. Corresponding to the relative levels of the third planar coil layer 50 and the fourth planar coil layer 60, pad 61 extends upward at position P4. Connection continues to coil main body 60 and stops at pad 62 at position P5, which extends to form a bonding pad. In this winding assembly pads 31, 51 and 61 at positions P1, P3 and P5, respectively, provide the possibility of being bonded to a printed circuit board using the SMT technology.

Arrangements and combinations of the invented modularized planar coil layers are not limited to the examples of FIG. 1 and FIG. 6. For example, the first to fifth positions P1-P5 may be arranged in different orders. The pad positions are not limited to five. Pads for other purposes may be provided. The series connection of the coil layers may be modified, without the need to follow a level order. For example, a coil at a middle level may connect a coil at a higher level, which then connects a coil at a lower level. Since this invention has provided a modularized structure of the planar coil, each planar coil layer has a substantially identical main body structure. The modularized structure provides designers the possibility of realizing a variety of planar coil assemblies by changing only certain factors of the module, such as position and length/height of pads, according to the needs in particular applications. Planar coil modules of different number of layers may be easily obtained.

Any commercially available method may be used to connect the planar coil layers. Usable methods include welding, adhesion, cold forging, fusion etc., as long as the planar coil modules are in secured electrical connection. Insulation sheets may be provided neighboring to each planar coil layer Material, size and thickness of the insulation sheets are not limited and are determined according to relative conditions in application. If necessary, adhesives may be applied to one or both surfaces of the insulation sheets, so to secure the planar coil layers. In addition, insulation layers may be applied to surface of the coils.

When assembly, the coil main bodies are preferably overlapped. Coils of the primary winding are preferably overlapped with coils of the secondary winding. In some applications, coils of the primary winding offset or interpose coils of the secondary winding.

When the planar coil layers are connected in series in a way shown in FIG. 6, a winding structure with four layers is formed and three bonding pads are provided. The winding assembly may be bonded to a circuit board using the SMT technology. Of course, if only two bonding pads are needed, bonding pad 51 may be omitted, whereby pad 51 simply serves to lap with pad 42. However, the bonding pad is preferably provided to stabilize the structure of the planar coil assembly, even if electrical or electronic connection is not necessary.

As described above, the present invention provides a modularized structure for the planar coil. The modularized planar coil layer defines pad positions, so that a plurality of planar coils may be easily connected. The invention allows a designer to design a planar coil assembly with desired number of layers. No printed circuit board is needed in the preparation of the invented planar coil layers. Thickness of the planar transformer is thus dramatically reduced. In addition, resistance generated in the assembly is reduced and performance thereof is thus improved.

What is claimed is:

1. A modularized planar coil, comprising a coil main body and two pads extended from both ends of the coil main body, wherein the pads respectively locate at a first position at periphery of an imaginary geometric shape that encloses the coil main body and a second position apart from the first position at peripheral of the geometric shape.

2. The planar coil according to claim 1, wherein the geometric shape is a rectangle enclosing the coil main body.

3. The planar coil according to claim 1, wherein the geometric shape is a polygon enclosing the coil main body.

4. The planar coil according to claim 1, further comprising an insulation sheet, wherein the main body is provided on the insulation sheet and the pads extend to external of the insulation sheet.

5. The planar coil according to claim 1, wherein the main body forms substantially a donut shape.

6. The planar coil according to claim 1, wherein the main body forms substantially a loop of polygon frame.

7. A planar coil assembly, comprising at least a first planar coil layer and a second planar coil layer;
wherein the first and second planar coil layers respectively comprise a coil main body and two pads extended from both ends of the coil main body;
wherein the two coil main bodies have substantially identical shapes, are stacked and are separated by a first predetermined distance;
wherein pads of the first planar coil layer respectively locate at a first position at periphery of an imaginary geometric shape that encloses the coil main bodies and a second position apart from the first position at peripheral of the geometric shape;
wherein pads of the second planar coil layer respectively locate at a second position at periphery of the imaginary geometric shape a third position apart from the first and second positions at peripheral of the geometric shape; and
wherein the first and second planar coil layers are connected in series at the second position.

8. The planar coil according to claim 7, further comprising an insulation sheet, provided between the first and second planar coil layers, wherein all pads extend to external of the insulation sheet.

9. The planar coil according to claim 7, wherein pads at the first and third positions respectively form a bonding pad at the same plane.

10. The planar coil according to claim 7, further comprising a third planar coil layer, said third planar coil layer comprising a coil main body and two pads extended from both ends of the coil main body;
wherein the coil main body has a shape substantially identical to that of the first and second planar coil layers, is stacked to the first and second planar coil layers and separated from its neighboring planar coil layer at a second predetermined distance;
wherein pads of the third planar coil layer respectively locate at the third position at periphery of the imaginary geometric shape and a fourth position apart from the first to third positions at peripheral of the geometric shape; and
wherein the third and second planar coil layers are connected in series at the third position.

11. The planar coil according to claim 10, further comprising an insulation sheet, provided between the third and second planar coil layers.

12. The planar coil according to claim 10, wherein the first and second predetermined distances are identical.

13. The planar coil according to claim 10, further comprising a fourth planar coil layer, said fourth planar coil layer comprising a coil main body and two pads extended from both ends of the coil main body;
wherein the coil main body has a shape substantially identical to that of the first to third planar coil layers, is stacked to the first to third planar coil layers and separated from its neighboring planar coil layer at a third predetermined distance;
wherein pads of the fourth planar coil layer respectively locate at the fourth position at periphery of the imaginary geometric shape and a fifth position apart from the first to fourth positions at peripheral of the geometric shape; and
wherein the fourth and third planar coil layers are connected in series at the fourth position.

14. The planar coil according to claim 13, wherein the third predetermined distance is identical to one of the first and second predetermined distances.

15. The planar coil according to claim 13, wherein pads at the first and fifth positions respectively form a bonding pad at the same plane.

16. The planar coil according to claim 13, wherein pads at the first, third and fifth positions respectively form a bonding pad at the same plane.

17. A planar transformer, comprising a planar coil layer according to claim 1, a planar coil module stacked to the planar coil layer and a core, wherein the core extends orthogonally to the plane of the planar coil layer and the planar coil modules and passes through their central portions.

18. The planar coil according to claim 17, further comprising a casing enclosing the core and the coil portions of the planar coil layer and planar coil modules.

19. A planar transformer, comprising a planar coil layer according to claim 7, a planar coil module stacked to the planar coil layer and a core, wherein the core extends orthogonally to the plane of the planar coil layer and the planar coil modules and passes through their central portions.

20. The planar coil according to claim 19, further comprising a casing enclosing the core and the coil portions of the planar coil layer and planar coil modules.

21. A planar transformer, comprising a planar coil layer according to claim 10, a planar coil module stacked to the planar coil layer and a core, wherein the core extends orthogonally to the plane of the planar coil layer and the planar coil modules and passes through their central portions.

22. The planar coil according to claim 21, further comprising a casing enclosing the core and the coil portions of the planar coil layer and planar coil modules.

23. A planar transformer, comprising a planar coil layer according to claim 13, a planar coil module stacked to the planar coil layer and a core, wherein the core extends orthogonally to the plane of the planar coil layer and the planar coil modules and passes through their central portions.

24. The planar coil according to claim 23, further comprising a casing enclosing the core and the coil portions of the planar coil layer and planar coil modules.
